(19) United States
(12) Patent Application Publication
(10) Pub. No.: US 2011/0070750 A1
(43) Pub. Date: Mar. 24, 2011

(54) ELECTRICAL CONNECTOR HAVING A SEQUENTIAL MATING INTERFACE

(75) Inventors: JASON M'CHEYNE REISINGER, CARLISLE, PA (US); SCOTT STEPHEN DUESTERHOEFT, ETTERS, PA (US)

(73) Assignee: TYCO ELECTRONICS CORPORATION, BERWYN, PA (US)

(21) Appl. No.: 12/565,497

(22) Filed: Sep. 23, 2009

(51) Int. Cl. H01R 12/00

(52) U.S. Cl. 439/66

(57) ABSTRACT

An interconnect assembly for interconnecting first and second electrical components includes a substrate having opposed first and second surfaces. The interconnect assembly also includes a first array of contacts on the first surface for engaging corresponding elements on the first electrical component. The first array of contacts have first and second subsets that extend different first and second distances from the substrate to define a compressible interface that sequentially mates with the first electrical component such that the first subset of the contacts engages the first electrical component prior to engagement by the second subset of contacts. The interconnect assembly further includes a second array of contacts on the second surface for engaging corresponding elements on the second electrical component.

### BACKGROUND OF THE INVENTION

The subject matter herein relates generally to interconnecting circuit boards, and more particularly, to electrical connector assemblies that are configured to electrically couple arrays of contacts.

Some electrical systems, such as servers, routers, and data storage systems, utilize electrical connector assemblies for transmitting signals and/or power through the electrical system. The electrical connector assemblies are used to interconnect various electrical components together, such as circuit boards, chip carriers or similar substrates that are circuitized or metallized. The electrical components typically have a grip array of contacts, to which the electrical connector assemblies are connected. The electrical connector assemblies typically include a substrate having contacts arranged on both sides thereof for interfacing with the grid arrays of the electrical components.

However, known electrical connector assemblies are not without disadvantages. For instance, the interfaces between the grid arrays are complex and may include more than one type of contact, such as power contacts, signal contacts and/or ground contacts. During mating, all of the contacts interface simultaneously. However, in some applications it may be preferred to have the different types of contacts mating at different times during the mating sequence. Therefore, a need exists for an electrical interface assembly having different subsets of contacts that connect and disconnect with one or more electrical components at different times.

### BRIEF DESCRIPTION OF THE INVENTION

In one embodiment, an interconnect assembly is provided for interconnecting first and second electrical components. The interconnect assembly includes a substrate having opposed first and second surfaces. The interconnect assembly also includes a first array of contacts on the first surface for engaging corresponding elements on the first electrical component. The first array of contacts have first and second subsets that extend different first and second distances from the substrate to define a compressible interface that sequentially mates with the first electrical component such that the first subset of the contacts engages the first electrical component prior to engagement by the second subset of contacts. The interconnect assembly further includes a second array of contacts on the second surface for engaging corresponding elements on the second electrical component.

Optionally, the contacts of the first array of contacts may include a beam extending between a base and a tip portion, where some of the contacts have different lengths than other contacts. The contacts of the first array of contacts may define an outer mating interface and an inner mating interface arranged closer to the first surface of the substrate than the outer mating interface. The contacts of the first subset of contacts have a first length and the contacts of the second subset of contacts having a second length shorter than the first length. The contacts of the first array of contacts may include beams extending at an angle with respect to the first surface, with each of the beams being at approximately the same angle. At least some of the beams may have different lengths. Some of the beams may be angled at a first angle and other beams being angled at a different angle.

Optionally, the first array of contacts may include a first subset of contacts having mating ends spaced apart from the first surface by a first distance, and a second subset of contacts having mating ends spaced apart from the first surface by a second distance. The first subset of contacts may engage the elements of the first electrical component prior to the second subset of contacts. The first array of contacts may include a third subset of contacts having mating ends spaced apart from the first surface by a third distance. The second subset of contacts may engage the elements of the first electrical component prior to the third subset of contacts. At least one of the first, second and third subsets of contacts may include power contacts. The first subset of contacts may include ground contacts, and the second subset of contacts may include signal contacts. The second subset of contacts may include sensing contacts.

In another embodiment, an interconnect assembly for interconnecting first and second electrical components is provided that includes a substrate having opposed first and second surfaces, primary contacts defining a mating interface above the first surface for engaging corresponding elements on the first electrical component where the primary contacts are elevated above the first surface by a first distance, and secondary contacts defining a mating interface above the first surface for engaging corresponding elements on the first electrical component where the secondary contacts are elevated above the first surface by a second distance. The primary contacts and the secondary contacts define a compressible interface having the primary contacts making initial engagement with the elements of the first electrical component and the secondary contacts making subsequent engagement with the elements of the first electrical component.

In a further embodiment, an interconnect assembly is provided for interconnecting first and second electrical components. The interconnect assembly includes a substrate having opposed first and second surfaces, and a plurality of contacts extending from the first surface for engaging corresponding elements on the first electrical component. The contacts include beams having predetermined lengths that are angled from the first surface at predetermined angles. The lengths and the angles are selected such that the contacts are elevated above the first surface at different heights to engage the elements of the electrical component according to a sequenced mating scheme.

### BRIEF DESCRIPTION OF THE DRAWINGS

FIG. 1 is a perspective view of an electrical system formed in accordance with one embodiment.

FIG. 2 is a cross-sectional view of a primary circuit board and a moveable interconnect assembly that may be used with the electrical system shown in FIG. 1.

FIG. 3 is a front perspective view of an electrical connector assembly for the electrical system shown in FIG. 1.

FIG. 4 is a cross-sectional view of the electrical connector assembly shown in FIG. 3.

FIG. 5 illustrates an alternative electrical system that utilizes an interconnect assembly formed in accordance with an alternative embodiment.

FIG. 6 is a side view of the interconnect assembly shown in FIG. 5.

FIG. 7 is a cross-sectional view of an interconnect assembly formed in accordance with an exemplary embodiment.

FIG. 8 is a cross-sectional view of another alternative interconnect assembly.

FIG. 9 is a cross-sectional view of yet another alternative interconnect assembly.

### DETAILED DESCRIPTION OF THE INVENTION

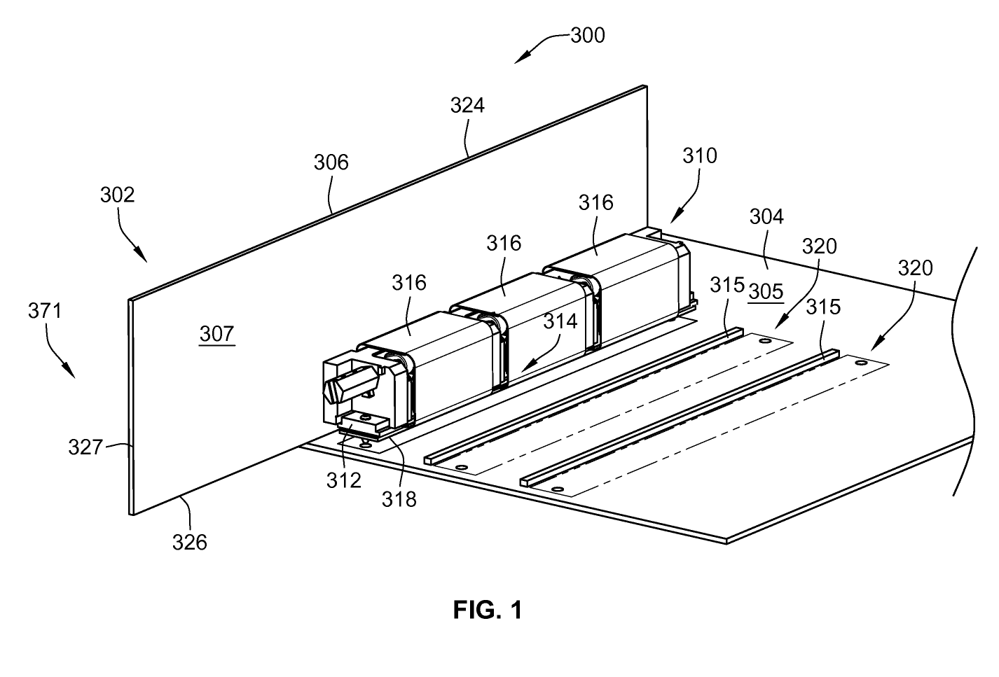

FIG. 1 is a perspective view of an electrical system 300 formed in accordance with one embodiment that includes an electrical connector assembly 310 used to interconnect first and second electrical components 304, 306 together. In the illustrated embodiment, the first electrical component 304 represents a circuit board and may be referred to hereinafter as a primary circuit board 304. The second electrical component 306 also represents a circuit board and may be referred to hereinafter as a secondary circuit board 306. The electrical connector assembly 310 may be used to interconnect electrical components other than circuit boards together in alternative embodiments.

The secondary circuit board 306 has a mating surface 307 and the electrical connector assembly 310 is coupled to the surface 307 of the secondary circuit board 306. The secondary circuit board 306 and the electrical connector 310 together define removable card connector assembly 302 that is removably coupled to the primary circuit board 304. The electrical connector assembly 310 includes a separable mating interface 312 that is configured to be separably coupled to the primary circuit board 304. In particular, the mating interface 312 is configured to be mated with a system contact array 320 of contacts along a surface 305 of the primary circuit board 304.

As one example for the electrical system 300, the card connector assembly 302 may be a part of a server blade and the primary circuit board 304 may be a mother board of a server system. However, the electrical system 300 shown in FIG. 1 may be a variety of other electrical systems, such as a router system or data storage system. Furthermore, although the illustrated embodiment is described with reference to interconnecting the primary and secondary circuit boards 304 and 306, the description herein is not intended to be limited to circuit boards. Embodiments described herein may be used to interconnect other electrical components where one component has an array of contacts and the other component has a complementary array of contacts. For example, embodiments described herein may be used as an interconnect assembly between an electrical component such as a circuit board and an integrated circuit (IC) component, such as a chip.

When the card connector assembly 302 and the primary circuit board 304 are to be engaged, the card connector assembly 302 may be advanced in a longitudinal mating direction along the primary circuit board 304. For example, the card connector assembly 302 may slidably engage guiding features 315, and slide to a predetermined position and orientation with respect to the contact array 320. Once the card connector assembly 302 is properly positioned alongside the contact array 320, the mating interface 312 may be moved to engage the contact array.

The electrical connector assembly 310 includes a circuit assembly 314 having the mating interface 312, one or more moveable interconnect assemblies 318, and one or more flexible circuits 316. The circuit assembly 314 communicatively couples the primary and secondary circuit boards 304 and 306 by providing conductive paths therebetween. The interconnect assemblies 318 are configured to be moved toward and away from the contact array 320 of contacts on the primary circuit board 304. As will be discussed in greater detail below, embodiments described herein are configured to move the interconnect assembly 318 between a retracted position and an engaged position. When in the engaged position, the electrical connector assembly 310 is electrically coupled to the contact array 320 through the interconnect assembly 318. Accordingly, the electrical connector assembly 310 is configured to interconnect the primary and secondary circuit boards 304 and 306. The electrical connector assembly 310 may be similarly moved to the retracted position by separating the interface with the primary circuit board 304. The electrical connector system 310 may be removed from the electrical system 300 when disengaged from the primary circuit board 304.

As shown in FIG. 1, the electrical connector assembly 310 is affixed to the secondary circuit board 306 and movable to engage the primary circuit board 304. However, in alternative embodiments, the electrical connector assembly 310 may be affixed to the primary circuit board 304 and be configured to engage a secondary circuit board when the secondary circuit board is inserted into the electrical system 300.

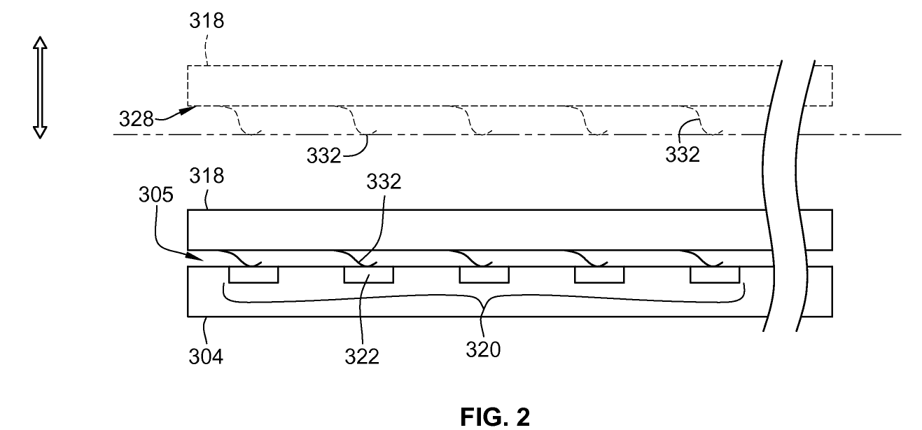

FIG. 2 is a cross-sectional view illustrating the interconnect assembly 318 in a retracted position (shown in dashed lines) and in an engaged position (solid lines) with respect to the primary circuit board 304. The circuit assembly 314 (shown in FIG. 1) is configured to allow the interconnect assembly 318 to be moved bi-directionally in a linear manner between the retracted position and the engaged position. As shown, the contact array 320 of the primary circuit board 304 has contacts 322 and the interconnect assembly 318 has contacts 332. The contacts 332 have different lengths such that mating interfaces of different contacts 332 engage the contacts 322 at different stages of mating. A sequenced mating interface is defined by the different length contacts 332. In the retracted position, the contacts 332 of the interconnect assembly 318 are spaced from corresponding contacts 322 of the primary circuit board 304. In the engaged position, each contact 332 is electrically coupled to or engaged to one of the contacts 322. The interconnect assembly 318 may be held and moved toward the primary circuit board 304 until the corresponding the contacts 322 and 332 are engaged. The longer contacts 332 engage the contacts 322 first, and the shorter contacts 332 engage the contacts 322 at a later time. The interconnect assembly 318 may also be disengaged from the primary circuit board 304.

The interconnect assembly 318 may be moved toward the primary circuit board 304 in a linear manner. Alternatively, the interconnect assembly 318 may be moved toward and engage the primary circuit board 304 in a non-linear manner. For example, the interconnect assembly 318 may approach the primary circuit board 304 at an angle or along a rotated path until the contacts 322 and contacts 332 become aligned and engaged. The board surface 305 and the mating surface 328 may not be parallel when in the retracted position, but may become aligned and parallel with each other when the interconnect assembly 318 is in the engaged position.

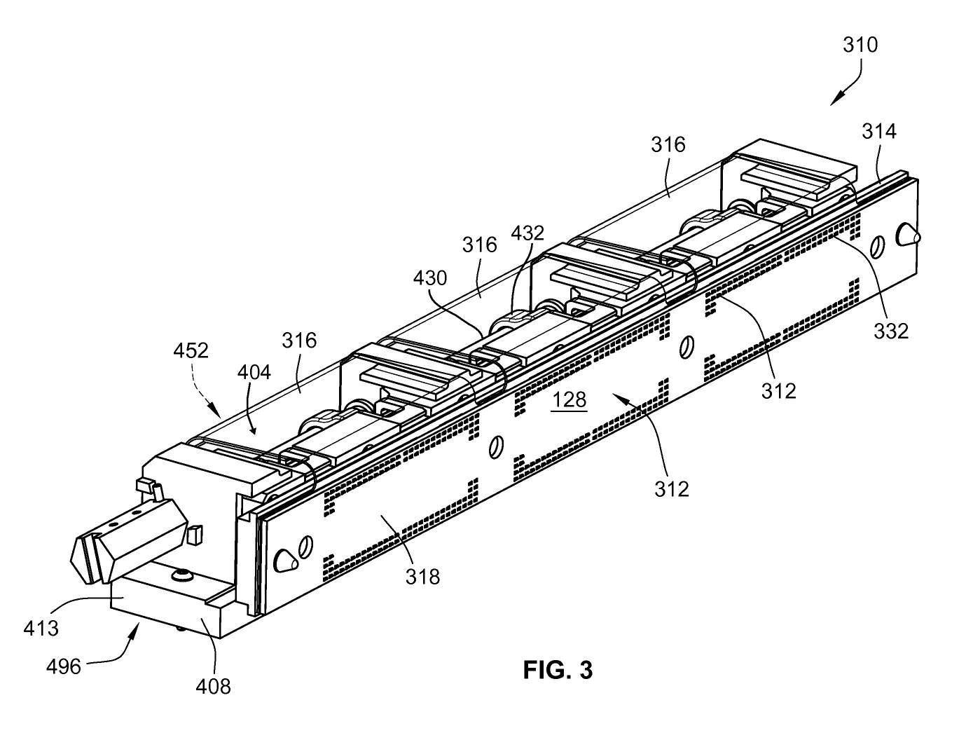

FIG. 3 is a front perspective view of the mating interface 312 of the electrical connector assembly 310. The electrical connector assembly 310 may include a base frame 408 and a coupling mechanism 404 that is supported by the base frame 408. The base frame 408 may be coupled (e.g., fastened) to the secondary circuit board 306 (shown in FIG. 1) so that the base frame 408 has a fixed relationship with respect to the secondary circuit board 306. The electrical connector assembly 310 includes the circuit assembly 314 that includes the flexible circuits 316 coupled to the mating interface 312. The circuit assembly 314 also includes the interconnect assembly 318 and another interconnect assembly 413. The flexible circuits 316 (also called flex circuit sections) are coupled to the interconnect assembly 413 at a board side 496 of the electrical connector assembly 310 and extend around the electrical connector assembly 310 to the mating interface 312.

The coupling mechanism 404 is configured to move the mating interface 312 between the retracted and engaged positions. The coupling mechanism 404 includes an axle 430 and cams 432 coupled to the axle 430. The cams 432 are either directly or indirectly coupled to the interconnect assembly 318. The axle 430 is rotated to move the cams 432, and thus the mating interface 312 between the retracted and engaged positions. Other types of mechanisms may be used in alternative embodiments to move the separable interface at the mating interface 312 between the retracted and engaged positions.

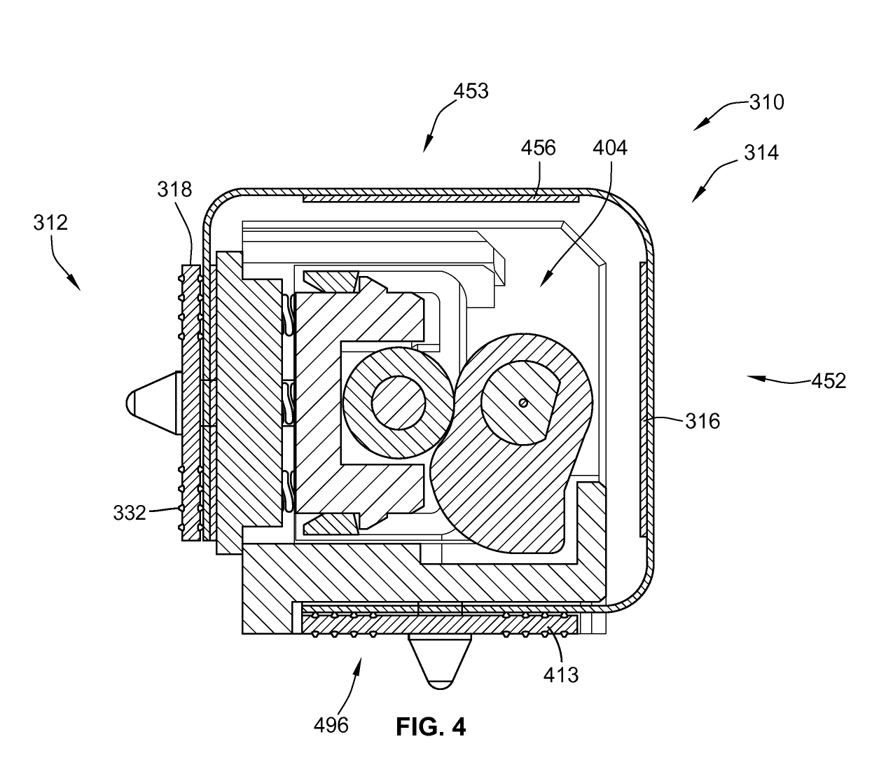

FIG. 4 is cross-sectional view of the electrical connector assembly 310. As shown, the flexible circuit 316 extends around the coupling mechanism 404 to communicatively couple the interconnect assembly 413 on the board side 496 to the interconnect assembly 318 of the mating interface 312. More specifically, the flexible circuit 316 extends around a perimeter of the cross-section of the electrical connector assembly 310 from the interconnect assembly 413 along non-mating sides 452 and 453. The flexible circuit 316 and/or the circuit assembly 314 may include rigid substrates or board stiffeners 456 for supporting and providing a shape to the flexible circuit 316.

The interconnect assemblies 318 and 413 and the flexible circuit 316 of the circuit assembly 314 may be assembled together into one unit. The interconnect assembly 413 extends between and engages the flexible circuit 316 on one side of the interconnect assembly 413 and the secondary circuit board 306 (shown in FIG. 1) on the other side of the interconnect assembly 413. The contacts of the interconnect assembly 413 may include contact beams, press-fit contacts or solder-ball contacts that are affixed to the secondary circuit board 306 to maintain an electrical connection with the secondary circuit board 306. Alternatively, other types of contacts may be used.

The mating interface 312 includes the interconnect assembly 318. The interconnect assembly 318 extends between and engages the flexible circuit 316 on one side of the interconnect assembly 318 and engages the primary circuit board 304 (shown in FIG. 1) on the other side of the interconnect assembly 318. The contacts 332 of the interconnect assembly 318 include the beams extending from the interconnect assembly 318 for engaging the primary circuit board 304. Alternatively, the contacts 332 may extend directly from the flexible circuit 316 for engagement with the primary circuit board 304.

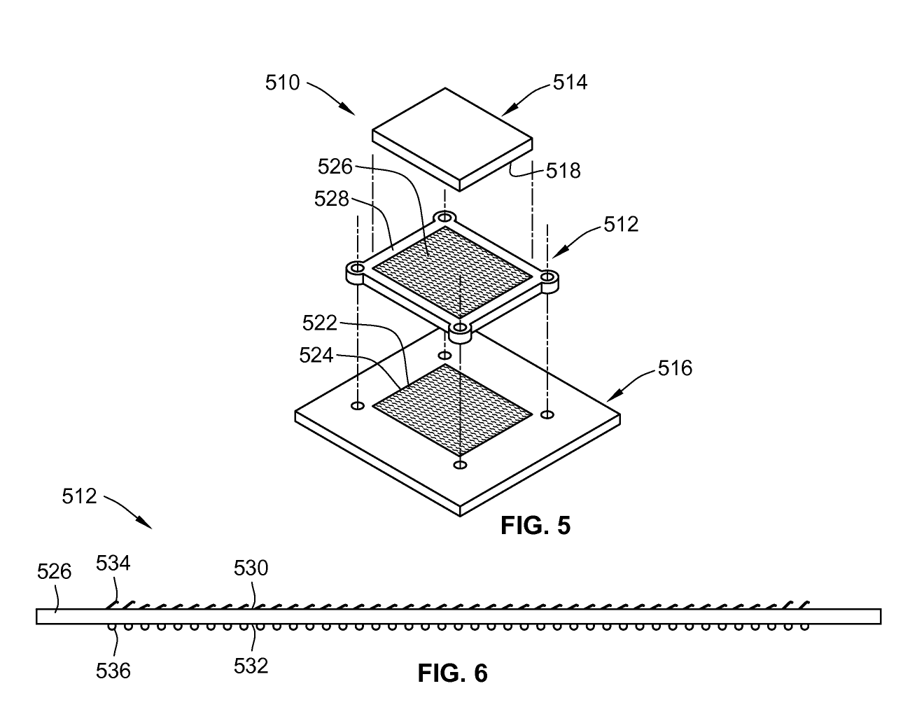

FIG. 5 illustrates an alternative electrical system 510 that utilizes an interconnect assembly 512 formed in accordance with an exemplary embodiment. The interconnect assembly 512 is used to interconnect a first electrical component 514 with a second electrical component 516. In the illustrated embodiment, the electrical component 514 is represented by an integrated circuit (IC) component such as an electronic package in the form of a chip or other circuitized module. The electrical component 516 is represented by a printed circuit board (PCB). The electronic package and PCB are merely illustrative of exemplary electrical components that may be interconnected by the interconnect assembly 512. Other types of electrical components may be similarly interconnected by the interconnect assembly 512 in alternative embodiments. For example, the interconnect assembly 512 may be used to interconnect two PCBs or two electronic packages in alternative embodiments.

The electrical component 514 includes a component mating face 518 for mating with the interconnect assembly 512. The component mating face 518 includes an array of mating elements, such as conductive pads, traces or contacts. The mating elements are arranged in a predetermined pattern for mating with the interconnect assembly 512. The electrical component 516 includes a component mating face 522 for mating with the interconnect assembly 512. The component mating face 522 includes an array of mating elements 524, such as conductive pads, traces or contacts. The mating elements 524 are arranged in a predetermined pattern for mating with the interconnect assembly 512.

The interconnect assembly 512 includes a substrate 526 and a socket frame 528 holding the substrate 526. The socket frame 528 may be attached to the electrical component 516 to position the interconnect assembly 512 with respect to the electrical component 516. The socket frame 528 is configured to hold the electrical component 514 therein. The electrical component 514 may be directly secured to the socket frame 528, or alternatively, a fastener or plate may be used to secure the electrical component 514 to the socket frame 528 and/or the electrical component 516. The socket frame 528 may be used to position the electrical component 514 with respect to the interconnect assembly 512.

FIG. 6 is a side view of the interconnect assembly 512 illustrating the substrate 526 with the socket frame 518 (shown in FIG. 5) removed for clarity. Optionally, the interconnect assembly 512 may be utilized without the use of the socket frame 518 to interconnect the electrical components 514, 516 (shown in FIG. 5).

The interconnect assembly 512 includes opposed first and second surfaces 530, 532. When assembled, the first surface 530 generally faces the electrical component 514 and the second surface 532 generally faces the electrical component 516. The interconnect assembly 512 includes a first array of contacts 534 provided on and/or extending from the surface 530. The contacts 534 are configured to electrically connect to corresponding mating elements on the electrical component mating face 518 (shown in FIG. 5). The interconnect assembly 512 includes a second array of contacts 536 provided on and/or extending from the surface 532. The contacts 536 are configured to electrically connect to corresponding mating elements 524 (shown in FIG. 5) on the second electrical component mating face 522 (shown in FIG. 5).

In an exemplary embodiment, the contacts 534 are separately provided from, and electrically connected to, the contacts 536. Alternatively, the contacts 534 may be integrally formed with the contacts 536 such that a portion of each contact is provided at the surface 530 and a portion of each contact is also provided at the surface 532. In the illustrated embodiment, the contacts 534 may represent spring contacts extending from the surface 530 and the contacts 536 may represent solder balls extending from the surface 532. Other types of contacts may be provided at either surface 530, 532 in alternative embodiments.

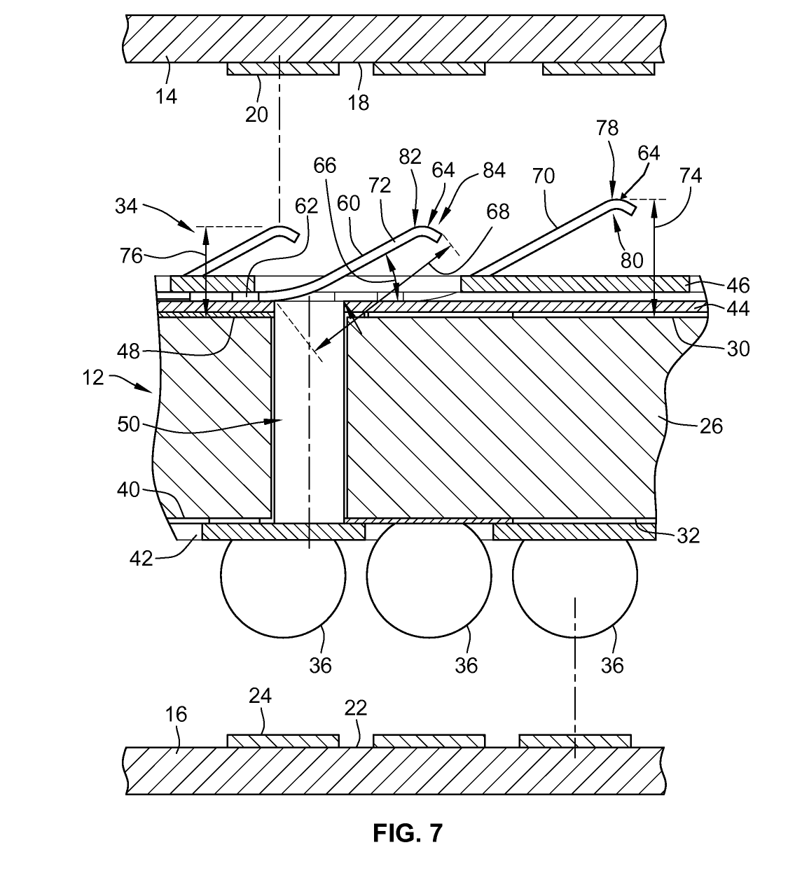

FIG. 7 is a cross-sectional view of a portion of another interconnect assembly 12. The interconnect assembly 12 may be used within the electrical system 300 (shown in FIG. 1-4), such as to replace the interconnect assembly 318 and/or the interconnect assembly 413, or any other interface therein depending on the particular application. Similarly, the interconnect assembly 12 may be used within the electrical system 510 (shown in FIGS. 5-6) to replace the interconnect assembly 512. The components and features of the interconnect assembly 12 may be used in whole or in part within the other interconnect assemblies or interfaces described herein.

The interconnect assembly 12 is used to interconnect a first electrical component 14 with a second electrical component 16. The electrical component 14 includes a component mating face 18 for mating with the interconnect assembly 12. The component mating face 18 includes an array of mating elements 20, such as conductive pads, traces or contacts. The electrical component 16 includes a component mating face 22 for mating with the interconnect assembly 12. The component mating face 22 includes an array of mating elements 24, such as conductive pads, traces or contacts. In the example of the electrical system 300, the first electrical component 14 may represent the primary circuit board 304 or the secondary circuit board 306 and the second electrical component 16 may represent the flexible circuit 316.

The interconnect assembly 12 includes a substrate 26 having opposite first and second surfaces 30, 32. When assembled, the first surface 30 generally faces the electrical component 14 and the second surface 32 generally faces the electrical component 16. The interconnect assembly 12 includes a first array of contacts 34 provided on and/or extending from the surface 30. The contacts 34 are configured to electrically connect to corresponding mating elements 20 on the electrical component mating face 18. In the example of the electrical system 300, the contacts 34 may represent the contacts 322.

The interconnect assembly 12 includes a second array of contacts 36 provided on and/or extending from the surface 32. The contacts 36 are configured to electrically connect to corresponding mating elements 24 on the second electrical component mating face 22. In an exemplary embodiment, a via pad 40 and coverlay 42 are applied to the surface 32 of the substrate 26. The contacts 36 are electrically and mechanically connected to the via pad 40.

The contacts 34 are secured to the substrate 26 by an adhesive 44. A coverlay 46 extends over portions of the contacts 34. Optionally, the contacts 34 may form part of a flexible circuit overlaying a rigid substrate. The contacts 34 extend outward from the flexible circuit for mating with the mating elements 20. In an exemplary embodiment, conductive traces 48 are provided on and/or routed through the substrate 26 to interconnect the contacts 34 and the contacts 36. Optionally, vias or through holes 50 may extend through the substrate 26, and the conductive traces 48 may extend from the surface 30 to the surface 32 through the via 50. A group of the contacts 34 may be electrically connected to corresponding ones of the contacts 36 by a dedicated conductive trace 48.

Each contact 34 includes a beam 60 extending between a base 62 and a tip portion 64. The end of the beam 60 may be curved such that the end of the tip portion 64 is positioned below another region of the tip portion 64. The base 62 is securely coupled to the substrate 26, such as by the adhesive 44. The base 62 is electrically connected to the conductive trace 48 to create the electrical path to the contacts 36. Optionally, a separate conductive element (not shown) may be provided between the contact 34 and the conductive trace 48 to create a conductive path therebetween.

The beam 60 of each contact 34 is angled at an angle 66 such that the tip portion 64 is elevated from the surface 30. Optionally, each of the beams 60 may have the same, or substantially the same, angle 66. Alternatively, some of the beams 60 may be angled at different angles 66 than other beams 60. The contacts 34 are resilient and may be flexed towards the surface 30 during mating with the electrical component 14. For example, when the tip portions 64 engage the electrical component 14 the beams 60 are compressed toward the surface 30. The contacts 34 thus define a compressible interface for mating with the electrical component 14.

The beams 60 of the contacts 34 have a length 68 measured between the base 62 and the tip portion 64. In an exemplary embodiment, some of the contacts 34 have different lengths 68 than other contacts 34. As such, the tip portions 64 of some contacts 34 may be elevated higher above the surface 30 than other of the contacts 34. The tip portion 64 defines the highest point of the beam 60 above the surface 30. As noted above, the end of the beam 60 may not necessarily be the highest point of the beam 60 as the end of the tip portion may be curved downward. The highest point of the beam 60 is the portion of the beam 60 that engages the electrical component 14. The length 68 and the angle 66 control the position of the highest point of the beam 60.

The contacts 34 are configured into multiple types of contacts, namely primary contacts 70 and secondary contacts 72. FIG. 7 illustrates an example of a primary contact 70 and a secondary contact 72. The primary contacts 70 form one subset and the secondary contacts 72 form another subset. The primary contact 70 has a length 68 that is longer than the length 68 of the secondary contact 72 such that the primary contact 70 extends to a point further from the substrate 26 than the secondary contact 72. Additionally, or alternatively, the primary contact 70 may have an angle 66 that is greater than the angle 66 of the secondary contact 72 such that the primary contact 70 extends to a point further from the substrate 26 than the secondary contact 72.

The tip portion 64 of the primary contact 70 is elevated above the surface 30 by a first distance 74. The tip portion 64 of the secondary contact 72 is elevated above the surface 30 by a second distance 76. The tip portion 64 of the primary contact 70 defines an outer mating interface 78 at or near a mating end 80 of the primary contact 70. The mating interface 78 is elevated above the surface 30 by the first distance 74. The primary contacts 70 are oriented such that the mating interfaces 78 of the primary contacts 70 are generally coplanar with one another. The tip portion 64 of the secondary contact 72 defines an inner mating interface 82 at or near a mating end 84 of the secondary contact 72 that is elevated above the surface 30 by the second distance 76. The secondary contacts 72 are oriented such that the mating interfaces 82 of the secondary contacts 72 are generally coplanar with one another.

The primary contacts 70 engage corresponding mating elements of the electrical component 14 prior to the secondary contacts 72 engaging corresponding mating elements of the electrical component 14 due to the fact that the outer mating interfaces 78 of the primary contacts 70 are disposed further from the surface 30 than the inner mating interfaces 82 of the secondary contacts 72. The primary contacts 70 make initial engagement with the mating elements and the secondary contacts 72 make subsequent engagement with the mating elements 20. By controlling the length 68 and/or the angle 66 of the beams 60, the height of the tip portions 64 above the surface 30 may be controlled to provide a compressible interface that sequentially mates with the electrical component 14.

The contacts 34 may constitute different types of contacts. For example, the contacts 34 may be signal contacts, ground contacts, power contacts, sensing contacts, and the like. The primary contacts 70 may include one or more types of contacts and the secondary contacts 72 may include one or more types of contacts.

In one exemplary embodiment, the primary contacts 70 may be power contacts and the secondary contacts 72 may be signal contacts and ground contacts. During mating with the electrical component 14, the primary contacts 70 and the secondary contacts 72 are sequentially mated with the power contacts being mated prior to the signal and ground contacts. As such, power may be transmitted across the primary contacts 70 prior to signals being transmitted across the secondary contacts 72.

In another exemplary embodiment, the primary contacts 70 may be ground contacts and the secondary contacts 72 may be signal contacts. During mating with the electrical component 14, the primary contacts 70 and the secondary contacts 72 are sequentially mated with the ground contacts being mated prior to the signal contacts. As such, the electrical components 14, 16 may be grounded with one another prior to signals being transmitted across the secondary contacts 72.

In a further exemplary embodiment, the primary contacts 70 may be power contacts, signal contacts and/or ground contacts and the secondary contacts 72 may be sensing contacts. During mating with the electrical component 14, the primary contacts 70 and the secondary contacts 72 are sequentially mated with the power contacts, signal contacts and/or ground contacts being mated prior to the sensing contacts. When the sensing contacts are mated with the electrical component 14, a signal indicating that the electrical components 14, 16 are fully mated may be transmitted across the sensing contacts, which may then allow power and/or signals to be transmitted across the primary contacts 70. For example, in such an embodiment, the electrical components 14, 16 do not transmit power and/or data until a signal from the sensing contacts is transmitted across the mating interface, which indicates that all contacts are mated as the sensing contacts are the last contacts to mate. Other configurations and arrangements of contacts are possible in alternative embodiments. Additionally, other layers of contacts may be used in alternative embodiments for sequential mating of more than two mating interfaces. The other layers may be positioned closer to the mating surface 30 or further from the mating surface 30 than the mating interfaces 78 and/or 82.

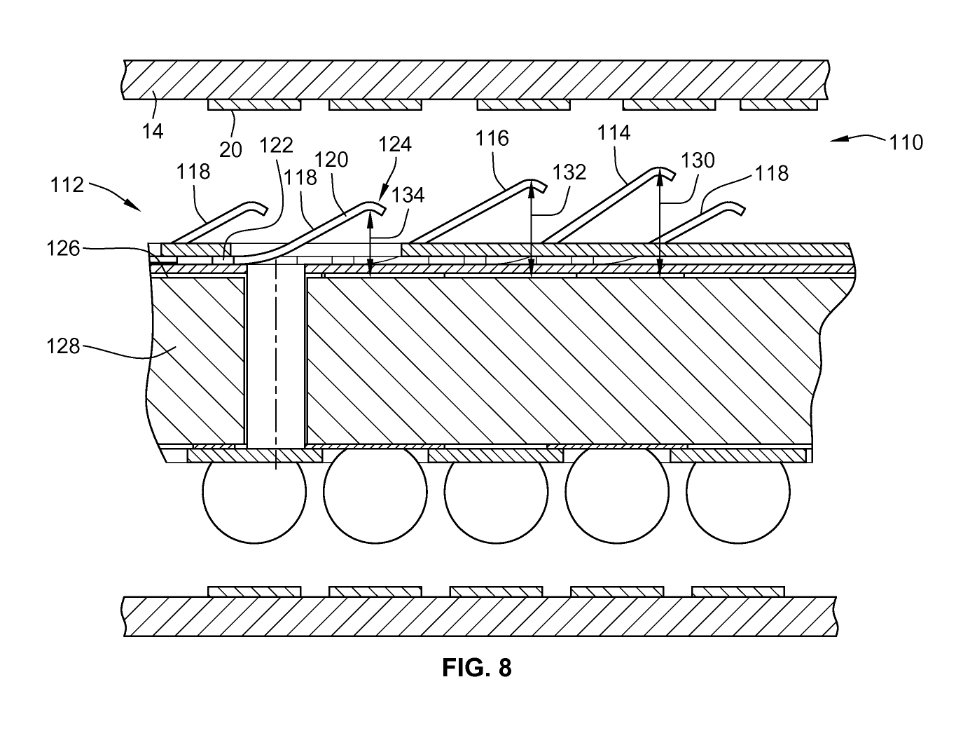

FIG. 8 is a cross-sectional view of an alternative interconnect assembly 112. The interconnect assembly 112 is similar to the interconnect assembly 12 but includes three layers of mating interfaces 110 for sequenced mating with the electrical component 14. The interconnect assembly 112 includes primary contacts 114, secondary contacts 116 and tertiary contacts 118. Each of the contacts 114, 116, 118 includes beams 120 extending from a base 122 to a tip portion 124. Different mating interfaces 110 are defined by the tip portions 124 for mating with mating elements of the electrical component 14.

The tip portions 124 of the primary contacts 114 are elevated above a first surface 126 of a substrate 128 of the interconnect assembly 112 by a first distance 130. The tip portions 124 of the secondary contacts 116 are elevated above the surface 126 by a second distance 132 that is less than the first distance 130. The tip portions 124 of the tertiary contacts 118 are elevated above the surface 126 by a third distance 134 that is less than the second distance 132. The tip portions 124 of the primary contacts 114 are generally coplanar with one another and define an outer mating interface that initially mates with the mating elements of the electrical component 14. The tip portions 124 of the secondary contacts 116 are generally coplanar with one another and mate with corresponding mating elements prior to the tip portions 124 of the tertiary contacts 118 mating with corresponding mating elements 20. By controlling a length and/or an angle of the beams 120 of the various contacts 114-118, the height of the tip portions 124 above the surface 126 may be controlled to provide a compressible interface that sequentially mates with the electrical component 14.

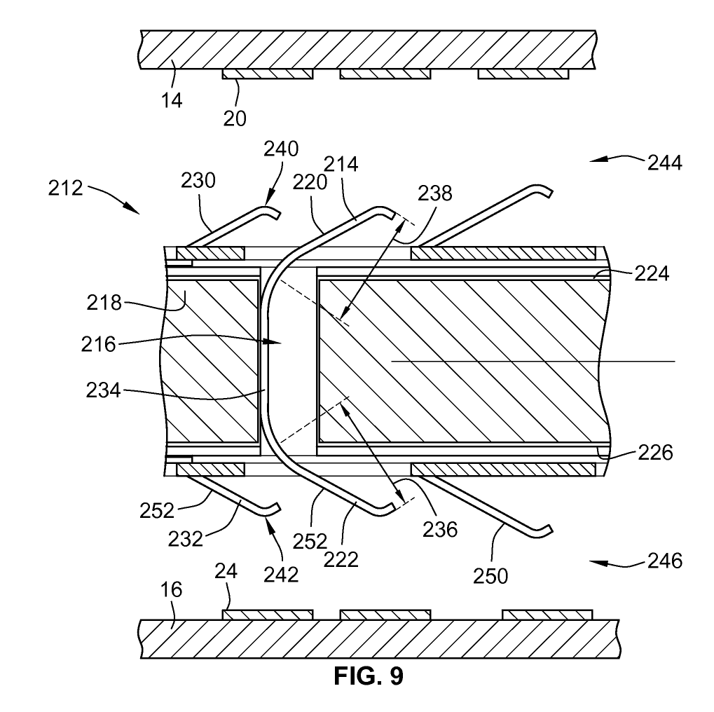

FIG. 9 is a cross-sectional view of another alternative interconnect assembly 212. The interconnect assembly 212 is similar to the interconnect assembly 12 but includes contacts 214 that extend through vias 216 in a substrate 218 of the interconnect assembly 212. The contacts 214 include first and second portions 220, 222 that are arranged on first and second surfaces 224, 226, respectively, of the substrate 218. The first and second portions 220, 222 mate with the mating elements 20, 24 of the electrical components 14, 16, respectively. The contacts 214 provide direct paths through the interconnect assembly 212 for interconnecting the electrical components 14, 16, as opposed to the indirect paths provided by the conductive traces 48 between the contacts 34 and the solder balls 36 of the interconnect assembly 12.

The contacts 214 include first and second beams 230, 232 and a post 234 extending therebetween. An intersection is defined by the post 234 and the beams 230, 232, where the beams 230, 232 are angled from the post 234 at the intersection. The beams 230, 232 have lengths 236, 238. The lengths 236, 238 may be substantially equal, such as in the illustrated embodiment, or alternatively, may be different from one another. The beams 230, 232 have mating ends 240, 242 generally opposite the post 234. The inward curving portion of the beams 230, 232 beyond the mating interfaces 244, 246 may be immaterial to the effective length and to how high the beam 230, 232 extends above the substrate 218. The inward curving portion of the beams 230, 232 may be excluded or removed from the beams 230, 232 in alternative embodiments.

In the illustrated embodiment, two different subsets of contacts 214 are illustrated. For example, FIG. 9 illustrates primary contacts 250 and secondary contacts 252. One of the differences between the primary contacts 250 and the secondary contacts 252 is that the primary contacts 250 define a mating interface 244, 246 that is further from the surfaces 224, 226 of the substrate 218. The primary contacts 250 engage corresponding mating elements 20, 24 of the electrical components 14, 16 prior to the secondary contacts 252 engaging corresponding mating elements 20, 24 of the electrical components 14, 16. The primary contacts make initial contact because the mating ends 240, 242 of the primary contacts 250 extend to a point further away from the surfaces 224, 226. The primary contacts 250 make initial engagement with the mating elements 20, 24 and the secondary contacts 252 make subsequent engagement with the mating elements 20, 24. By controlling the length and/or the angle of the beams 230, 232, the distance of the mating ends 240, 242 from the surfaces 224, 226 may be controlled to provide opposed compressible interfaces that sequentially mate with the electrical components 14, 16. In an alternative embodiment, only the first portion 220 or the second portion 222 may have a sequentially mated interface, while the other portion has a single mating interface where all of the contacts mate simultaneously.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. An interconnect assembly for interconnecting first and second electrical components, the interconnect assembly comprising:
a substrate having opposed first and second surfaces;
a first array of contacts on the first surface for engaging corresponding elements on the first electrical component, the first array of contacts having first and second subsets that extend different first and second distances from the substrate to define a compressible interface that sequentially mates with the first electrical component such that the first subset of the contacts engages the first electrical component prior to engagement by the second subset of contacts; and
a second array of contacts on the second surface for engaging corresponding elements on the second electrical component.

2. The interconnect assembly of claim 1, wherein the contacts of the first array of contacts include a beam extending between a base and a tip portion, some of the contacts have different lengths than other contacts.

3. The interconnect assembly of claim 1, wherein the contacts of the first array of contacts define an outer mating interface and an inner mating interface arranged closer to the first surface of the substrate than the outer mating interface.

4. The interconnect assembly of claim 1, wherein the contacts of the first subset of contacts have a first length and the second subset of contacts have a second length shorter than the first length.

5. The interconnect assembly of claim 1, wherein the contacts of the first array of contacts include beams extending at an angle with respect to the first surface, each of the beams being at approximately the same angle, wherein at least some of the beams have different lengths.

6. The interconnect assembly of claim 1, wherein the contacts of the first array of contacts include beams extending at an angle with respect to the first surface, some of the beams being angled at a first angle and other beams being angled at a different angle.

7. The interconnect assembly of claim 1, wherein the contacts are compressed toward the substrate when mated with the first electrical component.

8. The interconnect assembly of claim 1, wherein the first subset of contacts have mating ends spaced apart from the first surface by the first distance, and wherein the second subset of contacts having mating ends spaced apart from the first surface by the second distance.

9. The interconnect assembly of claim 8, wherein the first array of contacts include a third subset of contacts having mating ends spaced apart from the first surface by a third distance, the second subset of contacts engages the elements of the first electrical component prior to the third subset of contacts.

10. The interconnect assembly of claim 9, wherein at least one of the first, second and third subsets of contacts comprise power contacts.

11. The interconnect assembly of claim 8, wherein the first subset of contacts comprise ground contacts, and wherein the second subset of contacts comprise signal contacts.

12. The interconnect assembly of claim 8, wherein the second subset of contacts comprise sensing contacts.

13. The interconnect assembly of claim 1, wherein the contacts defining the second array of contacts include solder balls configured to be soldered to the elements on the second electrical component.

14. An interconnect assembly for interconnecting first and second electrical components, the interconnect assembly comprising:
a substrate having opposed first and second surfaces;
primary contacts defining a mating interface above the first surface for engaging corresponding elements on the first electrical component, the primary contacts being elevated above the first surface by a first distance; and
secondary contacts defining a mating interface above the first surface for engaging corresponding elements on the first electrical component, the secondary contacts being elevated above the first surface by a second distance;
wherein the primary contacts and the secondary contacts define a compressible interface having the primary contacts making initial engagement with the elements of the first electrical component and the secondary contacts making subsequent engagement with the elements of the first electrical component.

15. The interconnect assembly of claim 14, wherein the primary contacts have a first length and the secondary contacts have a second length shorter than the first length.

16. The interconnect assembly of claim 14, wherein the primary and secondary contacts include beams extending at an angle with respect to the first surface, each of the beams being at approximately the same angle, wherein the beams of the primary contacts have a different length than the beams of the secondary contacts.

17. The interconnect assembly of claim 14, wherein the primary contacts include beams extending at an angle with respect to the first surface, and wherein the secondary contacts include beams extending at a different angle than the primary contacts.

18. The interconnect assembly of claim 14, further comprising tertiary contacts defining a mating interface above the first surface for engaging corresponding elements on the first electrical component, the tertiary contacts being elevated above the first surface by a third distance less than the first and second distances such that the tertiary contacts engage the elements on the first electrical component subsequent to the primary and secondary contacts.

19. An interconnect assembly for interconnecting first and second electrical components, the interconnect assembly comprising:
a substrate having opposed first and second surfaces;
a plurality of contacts extending from the first surface for engaging corresponding elements on the first electrical component, the contacts include beams having predetermined lengths and being angled from the first surface at predetermined angles, the lengths and the angles being selected such that the contacts are elevated above the first surface at different heights to engage the elements of the electrical component according to a sequenced mating scheme.

20. The interconnect assembly of claim 19, wherein the contacts are arranged in at least two different subsets, the contacts of the different subsets defining mating interfaces that are generally coplanar with one another and non-coplanar with the contacts defining the other subsets.
